(19) United States
(12) Patent Application Publication
(10) Pub. No.: US 2026/0080384 A1
(43) Pub. Date: Mar. 19, 2026

(54) REDEMPTION KIOSK INCORPORATING A SLOT MANAGEMENT SYSTEM AND METHOD OF USING THE SAME

(71) Applicant: JCM American Corporation, Las Vegas, NV (US)

(72) Inventor: Rainer Seyer, Berlin (DE)

(21) Appl. No.: 18/886,859

(22) Filed: Sep. 16, 2024

(51) Int. Cl. G06Q 20/18; G07F 17/32; H04W 88/08

(52) U.S. Cl. CPC G06Q 20/18; G07F 17/3225; G07F 17/3258; H04W 88/08

(57) ABSTRACT

A kiosk for a non-casino location or small casino includes at least a processor, database, display, ticket validator and a slot management system wherein the slot management system is software-based program running on or in communication with the processor. The kiosk may also include one or more of the following: a bill dispenser, a card reader, a PIN pad, a camera, an electronic lock, a second processor, a bill validator and an uninterruptable power supply. In a non-casino location, the slot management system typically communicates with no more than fifteen local electronic gaming machines. The slot management system may handle accounting, player notification, security and other services associated with the local electronic gaming machines. A central server permits a plurality of kiosks to be communicatively linked.

### FIELD OF THE INVENTION

The embodiments of the present invention relate to a system involving a redemption kiosk incorporating a slot management system for managing a modest number of local gaming machines installed at a non-casino location or small casino.

### BACKGROUND

Over the past ten years or so, legalized gaming in the United States has exploded. With the increased legalization comes the desire by governments to permit gaming machines (e.g., slot machines, video poker machines, etc.) to be installed in non-casino locations such as taverns, horse tracks, truck stops and convenience stores. At least Nevada and Illinois allow small numbers of gaming machines in certain non-casino locations under restricted gaming licenses. More states are sure to follow. One drawback to installing a modest number of gaming machines in non-casino locations is the cost of a slot management system. Slot management systems are designed to manage large numbers of gaming machines in large casinos and are therefore costly. Moreover, such slot management systems need to run on large servers with significant processing power and storage.

It would be advantageous for smaller venues with smaller numbers of electronic gaming machines to utilize a more modest and cost-effective slot management system. Moreover, the slot management system should be configured to run locally at a non-casino location or small casino. More advantageously, the slot management system should be configured to run on a redemption style kiosk at the non-casino location or small casino.

### SUMMARY

One embodiment of the present invention involves a kiosk including a processor, a database, a display, a gaming ticket validator, and a slot management system, wherein said slot management system is software-based program running on or in communication with said processor, said slot management system communicatively linked to a plurality of local electronic gaming machines. In one embodiment, said slot management system is communicatively linked to no more than fifteen local electronic gaming machines in a non-casino location. Alternatively, said slot management system can communicatively linked to 100 or more local electronic gaming machines installed at a small casino.

In other embodiments, the kiosk may further include a bill dispenser, a card reader, a PIN pad, a camera, an electronic lock, a second processor and an uninterruptable power supply. In an embodiment having two processors, a first processor controls kiosk operations and a second processor runs the slot management system. In such an embodiment, each processor may be programmed to serve as a backup for the other processor.

In one embodiment, when a player cashes out at a gaming machine, the gaming machine prints a ticket with a barcode or QR code and sends the ticket number and the amount to the kiosk. The kiosk stores the ticket information in an internal database. When a players presents the ticket at the kiosk, the kiosk validates the ticket number in its internal database and pays out the corresponding ticket amount. The ticket is marked as paid to ensure a copy of the ticket cannot be redeemed.

In another embodiment, the player can validate a ticket at an electronic gaming machine whereby the electronic gaming machine sends a validation request to the kiosk. Responsive to validation, the electronic gaming machine credits the corresponding amount of the ticket to the electronic gaming machine for play.

In another embodiment, a second computer operates the slot management system and the ticket database while a first computer operates the redemption kiosk. If one of the two computers fails, the other computer is programmed to assume the tasks of the failed computer. Such an embodiment provides a level of redundancy.

In another embodiment, kiosks at each location are in communication with a central server such that the locations may participate in wide area jackpots and players may redeem tickets at any one of the locations.

Other variations, embodiments and features of the present invention will become evident from the following detailed description, drawings and claims.

### BRIEF DESCRIPTION OF THE DRAWINGS

The disclosure will be readily understood by the following detailed description in conjunction with the accompanying drawings, wherein like reference numerals designate like structural elements.

FIG. 1 is a front view of kiosk of the type useable with the embodiments of the present invention;

FIG. 2 is a block diagram illustrating an exemplary internal view a kiosk of the type useable with the embodiments of the present invention;

FIG. 3 is a block diagram illustrating a broader set of exemplary kiosk components of a kiosk of the type useable with the embodiments of the present invention;

FIG. 4 is a block diagram illustrating a kiosk network of a kiosk of the type useable with the embodiments of the present invention;

FIG. 5 is a block diagram illustrating a local kiosk system architecture according to the embodiments of the present invention; and

FIG. 6 is a block diagram illustrating exemplary kiosk components of a kiosk of the type used with the embodiments of the present invention.

Additionally, it should be understood that the proportions and dimensions (either relative or absolute) of the various features and elements (and collections and groupings thereof) and the boundaries, separations, and positional relationships presented therebetween, are provided in the accompanying Figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wired, wireless, wireline, optical fiber cable, RF, Bluetooth and the like, or any suitable combination of the foregoing. Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming machine” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

Those skilled in the art will recognize that certain types of EGMs, generally utilized in regulated casino environments, are still commonly referred to as “slot machines”. Although the etymology of the term “slot machine” was originally derived from a coin slot in the gaming machines at the time, coin slots have long since generally been replaced by payment input devices or bill validators which only accept paper currency or ticket-in-ticket-out vouchers and/or electronic fund transfer means, such as card readers, mobile device payment means or account interfaces. As a result, the term EGM and slot machine are used interchangeably and are defined to mean something different than a laptop or desktop computer, cell phones, tablet computer gaming devices and the like.

The embodiments described herein are generally, but not necessarily exclusively, directed to systems, devices, and methods for managing EGMs in non-casino locations (e.g., taverns) where a small number of EGMs are permitted. For example, Illinois allows businesses like bars and restaurants to have up to 6 slot machines and truck stops to have up to a total of 10 slots machines. Likewise, in Nevada, restaurants, taverns, convenience stores and the like may have up to 15 EGMs. It is foreseeable that many other jurisdictions will pass legislation allowing certain non-casino locations to install small numbers of EGMs to further expand the tax base. As used herein “non-casino locations” refer to locations having a primary business unrelated to gaming (e.g., convenience store) and operate a restricted number of electronic gaming machines.

In Nevada and Illinois, the non-casino locations utilize route operators to manage the electronic gaming machines. The route operators own, place and maintain the electronic gaming machines and typically lease them to the non-casino location or participate in a revenue share arrangement. Nevada and Illinois collectively have approximately 70,000 electronic gaming machines also referred to as video lottery terminals installed in roughly 10,000 non-casino locations.

Examples of the various systems, devices, and equipment operated by a casino and on-casino locations in conjunction with an electronic gaming device include bank note or bill acceptor/validators (or “bill validators”), gaming ticket receivers/printers, kiosks at which a user may obtain gaming credit (hereinafter, “credit”) or funds for wagering, routers, and antennas to provide wireless communications (such as Wi-Fi®, Bluetooth, radio frequency identification technologies, near field communication technologies, or other technologies), internet connection servers and systems, casino accounting services, and other systems and equipment. Such systems, devices, and equipment may be based in hardware or software. Such systems, devices, and equipment may be implemented, either in hardware or software, to provide secure transactions with the mobile device. Specific devices, methods, and systems operated by the casino are described in greater detail below.

The systems, methods, and devices described herein make use of a set of similar—but not necessarily identical—components. As used herein, the term “system” can also be used to refer to subsystems that may be used within other systems. As used herein, “component” will refer to a system, whether implemented in hardware or software, a subsystem, a device performing a certain operation, or a method of operation. Operations performed by the systems, methods, and devices may be performed using one or more processing units.

As used herein, a “CPU” or “processing unit” will refer to any of a processor, microprocessor, microcontroller, application specific integrated circuit and related circuitry, or other operational elements as would be known to one skilled in the art. Also encompassed by the term “component” are digital and analog communication elements, circuits, or devices, such as may be operable to send and/or receive signals or messages over a variety of communication channels. Such channels include, but are not limited to, fiber optic links, coax or twisted pair cable, other forms of wired connections, wireless connections such as Bluetooth, Wi-Fi®, cellular communication networks, various near field communication links, and the like.

As used herein a slot management system is a software-based system that manages a plurality of electronic gaming machines such as slot machines, video poker machines, keno machines and the like. Depending on the embodiment, the slot management system may provide accounting services, player notification services, player tracking services, security services, etc.

Described below are certain components to be used in subsequent block diagrams of the systems, methods, and devices that may be used in various embodiments disclosed herein. It is not implied that all such components are included in each embodiment, nor that the embodiments are limited to these components or devices. Less commonly used components may be described in relation to Figures. Similarly named components in the Figures may be similar in structure and/or operation, but may have differences; it is not implied they are identical devices.

Another such component may be the Player Interface Device. A Player Interface Device will refer herein to any device connected with an electronic gaming machine (EGM) or casino table game system or individual table game with which a user may interact, such as with a mobile device. A Player Interface Device can refer to, among other devices, a bill validator, a bill validator having a bezel containing communication technologies (NFC, optical code readers, or other technologies), a TITO System, a card (credit card, debit card, specialty card, etc.) reader, or another type of component.

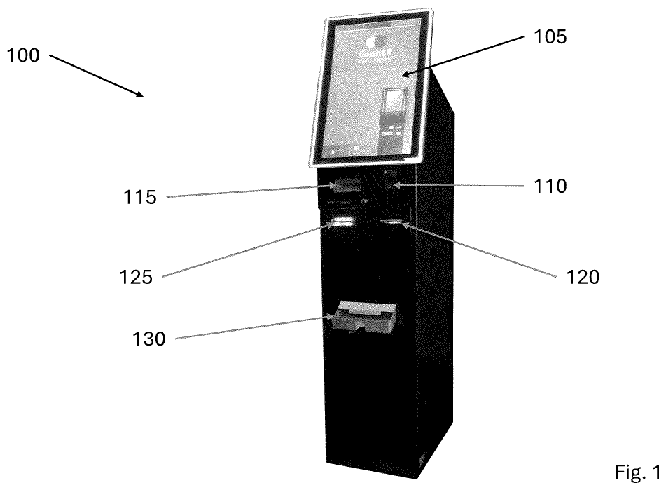

FIG. 1 shows an exemplary kiosk 100 of the type that may be used as part of the embodiments of the present invention. As shown, the kiosk 100 includes a display 105, card reader 110, ticket/currency reader 115, ticket and receipt printer 120, ticket dispenser 125 and currency dispenser 130. Those skilled in the art will recognize that the kiosk 100 may include other components without departing from the spirt and scope of the embodiments of the present invention.

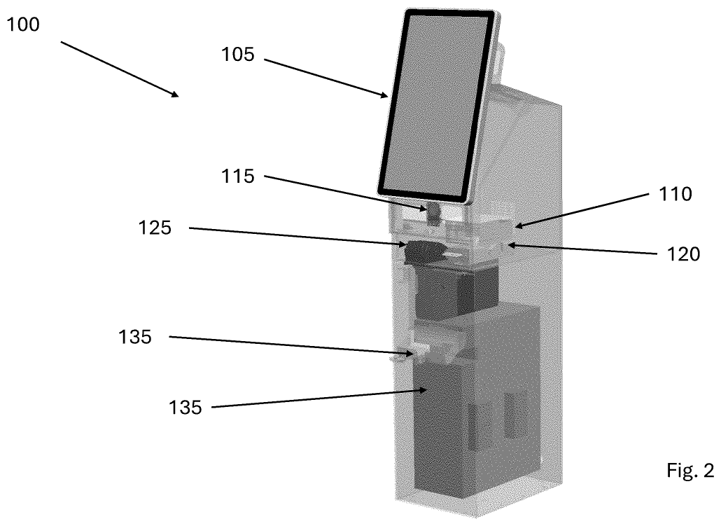

FIG. 2 shows certain internal components of the exemplary kiosk 100 of the type that may be used as part of the embodiments of the present invention. As shown, the kiosk 100 includes the display 105, card reader 110, ticket/currency reader 115, ticket and receipt printer 120, ticket dispenser 125, currency dispenser 130 and CPU 135. The CPU 135 runs the software (i.e., executable instructions) required for the kiosk 100 to perform its various functions.

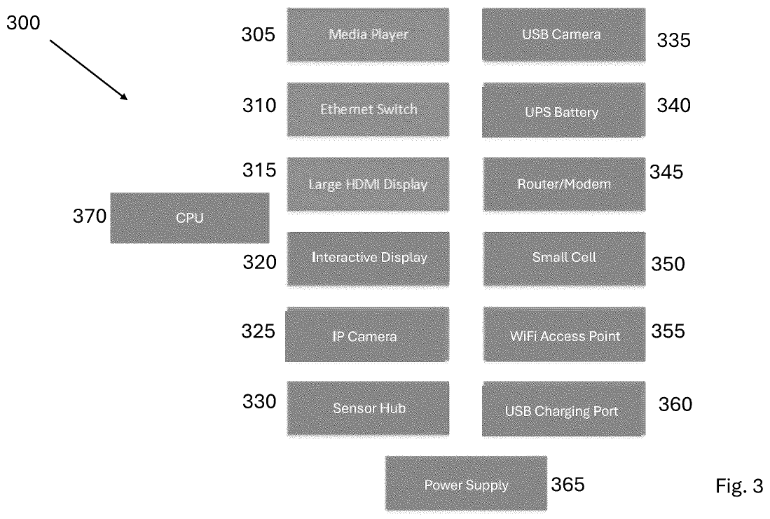

FIG. 3 shows a block diagram 300 detailing certain hardware associated with a kiosk of the type that may be used as part of the embodiments of the present invention. The hardware includes a media player 305, ethernet switch 310, display 315, interactive display 320, IP camera 325, sensor hub 330, USB camera 335, UPS battery 340, router/modem 345, small cell 350, WiFi access point 355, USB charging port 360, power supply 365 and CPU 370. The CPU 370 runs executable instructions for managing the components of the kiosk and their functionality. Those skilled in the art will recognize that a kiosk used with the embodiments of the present invention may have other components from those shown in FIG. 3 or not all the components shown in FIG. 3.

In one embodiment, the media player 305 controls various activities including streaming media for digital signage for advertisement and performing analytics on the content obtained through the IP camera 325 and transferring data to the cloud. The media player 305 can also work with content management software and analytics software. The media player 305 can also secure remote management.

In one embodiment, the ethernet switch 310 acts as a hub to which components like the media player 305, router/modem 345, small cell 350, IP camera 325, WiFi access point 355 and interactive display system 320 are connected. This enables interconnection between these components inside the kiosk. The router/modem 345 can be connected to the ethernet switch 310 on one end and to the network backhaul on the other end, so the components needing internet access can be connected to the ethernet switch 310. For example, in one embodiment, the media player utilizes an internet connection to upload data to the cloud and to be remotely managed. The IP camera 325 streaming can be monitored for surveillance and if it is connected to the ethernet switch 310, this can be remotely managed by a system administrator.

In one embodiment, display 315 is used to project content from the media player 305. The content can be advertisements. The display 315 can playback content which changes dynamically based on analytics data. In one embodiment, the interactive display 320 acts as a tool for interaction between the user and the kiosk. The interactive display 320 can be connected to the ethernet switch 310 for internet access.

In one embodiment, the IP camera 325 is used as a surveillance camera, when it is connected to the ethernet switch 310 and can be accessed by the system administrator to remotely monitor.

In one embodiment, the sensor hub 320 can connect to different 3rd party sensors for internal and external environment sensing. The sensor hub 320 can provide actuation of fans and display brightness in the kiosk based on temperature and luminance sensor readings. The sensor hub 320 can sense audio input to identify & trigger Public Safety related alerts related to gunshots, alarms, glass break etc. Additionally, the sensor hub 320 can aggregate face detection (age/gender) data and people counting data from Bluetooth® low energy, WiFi and analytics for uploading to a cloud.

In one embodiment, the USB camera 335 is used by some analytics software installed in the media player 305. The analytics software can use live stream from the USB camera 335 for analytics. The analytics could sense viewer responsiveness, determine gender, determine age group and measure the duration of a person's gaze, further enhancing the ability to track consumer behavior. The analytics can upload data to the cloud for review. Analytics software can maintain anonymity and privacy by not storing personal information.

In one embodiment, the UPS battery 340 provides temporary battery power when the utility power is out. The UPS battery 340 can thereby provide protection for electronic equipment from utility power blackouts, brownouts, sags, and surges, small utility power fluctuations and large disturbances. The UPS battery 340 can also provide battery backup power for connected equipment until utility power returns to safe levels or the batteries are fully discharged. The UPS battery 340 can have an ethernet port which allows the UPS battery 340 to be remotely managed.

In one embodiment, the router/modem 345 is used for failover/fallback which can provide maximum uptime, when configured. The router/modem 345 can detect network failures and seamlessly switches over to another active connected data source keeping the network online. The router/modem 345 can be connected to the internet from a network backbone and can be connected to the ethernet switch 310 to enable internet access for all components in the kiosk.

Mobile operators can use small cell 350 to extend their service coverage and/or increase network capacity. Small cell 350 can be used as alternate network backhaul if the main network handling the connectivity in kiosk setup fails. The small cell 350 can be connected to the core networking device.

In one embodiment, the WiFi access point 355 provides an internet hotspot facility for the kiosk users. The WiFi access point 355 can be connected to the network backbone. This can enable the WiFi access point 355 to provide the internet hotspot facility for the end users using the kiosk.

In one embodiment, the users of the kiosk can charge their batteries in their mobile devices using the USB charging port 360. In one embodiment, the power supply 365 is a conventional electrical plug configured to plug into an electrical outlet supplying 110V or 220V power.

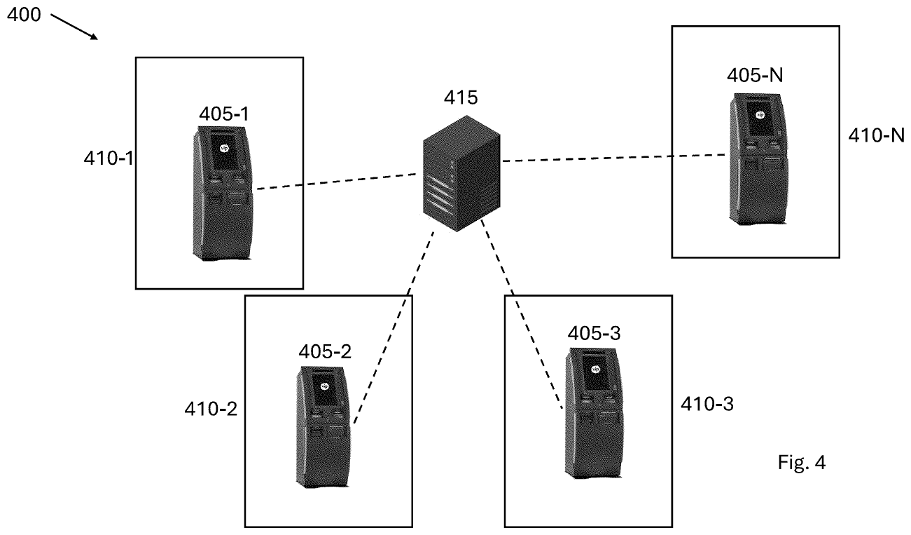

FIG. 4 is a block diagram showing a kiosk network 400 of the type that may utilized with the embodiments of the present invention. The kiosk network 400 comprises a plurality of kiosks 405-1 through 405-N located at individual non-casino locations 410-1 through 410-N. In one embodiment, the individual non-casino locations 410-1 through 410-N are commonly owned and/or operated. Each of the kiosks 405-1 through 405-N are in wireless communication with a remote central server 415. The remote central server 415 may be installed in one of the non-casino locations 410-1 through 410-N.

With the kiosk network 400, the data and information compiled by each kiosk 405-1 through 405-N may be transmitted to the remote central server 415 where it can be aggregated and analyzed across the network 400.

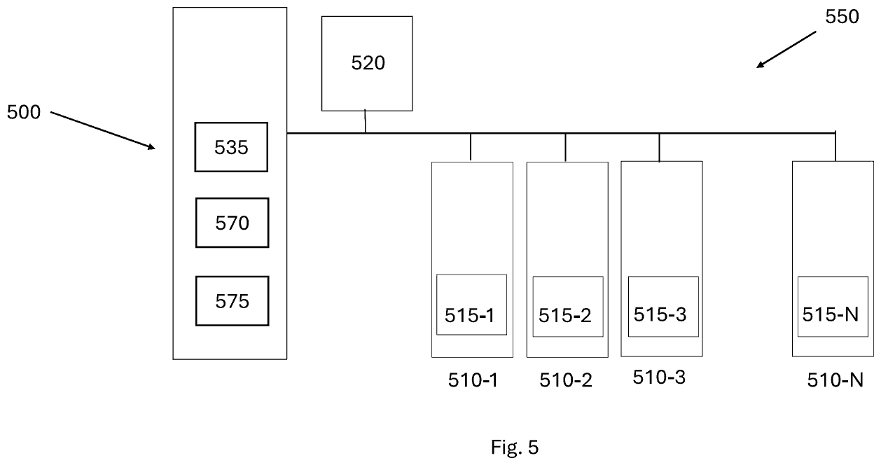

FIG. 5 shows an architectural schematic of a system according to the embodiments of the present invention. A kiosk 500 communicates with a plurality of EGMs 510-1 through 510-N. As detailed herein, the number of EGMs 510-1 through 510-N is approximately 15 or less as permitted in non-casino locations. In one embodiment, each EGM 510-1 through 510-N incorporates a slot machine interface board (SMIB) 515-1 through 5151-N. The SMIB 515-1 through 515-N of each EGM 510-1 through 510-N serves, among other things, to communicate with the kiosk 500. A network switch 520 manages communications between the EGMs 510-1 through 510-N, via the SMIBs 515-1 through 515-N, and the kiosk 500. The kiosk 500 may facilitate traditional services including debit and credit card transactions, bill breaking, etc.

A kiosk CPU 570 runs software to control kiosk functionality as detailed above. The kiosk CPU 570 also runs software configured as a slot/EGM management system 575 according to the embodiments of the present invention. The slot management system 575 facilitates accounting, ticketing and other features relative to the EGMs 510-1 through 510-N. The slot management system 575 is configured to manage approximately 15 EGMs or less.

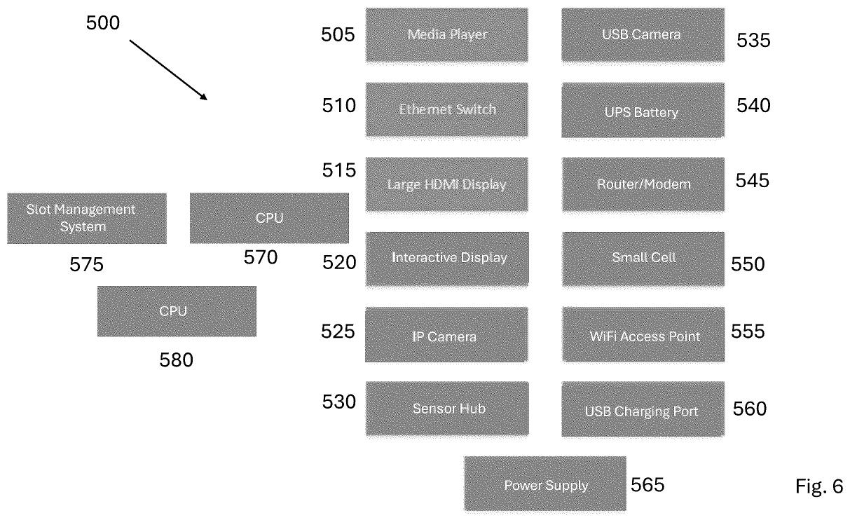

FIG. 6 shows a block diagram 600 detailing certain hardware associated with a kiosk used as part of the embodiments of the present invention. The hardware includes a media player 505, ethernet switch 510, display 515, interactive display 520, IP camera 525, sensor hub 530, USB camera 535, UPS battery 540, router/modem 545, small cell 550, WiFi access point 555, USB charging port 560, power supply 565, CPU 570 and slot management system 575.

In practice, when a player cashes out at an EGM 510-1 through 510-N, an EGM printer prints a gaming ticket with a barcode or QR code. Simultaneously, the EGM 510-1 through 510-N, via the SMIB 515-1 through 515-3, transmits a gaming ticket number and gaming ticket amount to the kiosk 500 where it is stored in a kiosk database 535. Ideally, the communications between the EGMs 510-1 through 510-N and kiosk 500 (and vice versa) are encrypted. In this manner, when a player presents the gaming ticket at the kiosk 500, the kiosk 500 validates the gaming ticket by reading the gaming ticket number and gaming ticket amount and/or barcode or QR code and compares them to data stored in the kiosk database 535. When a correspondence is identified, the kiosk 500 pays out the gaming ticket amount. After the payout is concluded, the kiosk 500 marks the subject gaming ticket as paid to prevent a subsequent payout.

In one embodiment, a player may validate a gaming ticket at the EGM 510-1 through 510-N. In this embodiment, SMIBs 515-1 through 515-N convert the EGM language from slot accounting system (SAS) (or other language) into ethernet protocol. SAS is a protocol used between gaming machines and casino host systems. This allows the slot machines to create and validate tickets which will be saved in the kiosk SMS database 535. For a limited number of gaming tickets, the SMIBs 515-1 through 515-N can operate without connection to the slot management system 575. The kiosk gaming ticket database 535 can be updated when the connection is re-established. Gaming tickets which have been printed without connection to the slot management system 575 can be redeemed when the connection has been re-established.

In practice, upon insertion of the gaming ticket into the ticket reader of an EGM 510-1 through 510-N, the subject SMIB 515-1 through 515-N transmits a validation request to the kiosk 500. Once a validation response is transmitted from the kiosk 500 back to the EGM 510-1 through 510-N, the EGM 510-1 through 510-N is credited the amount of the gaming ticket. Players may also insert cash into bill validators of the EGMs 510-1 through 510-N for immediate credits.

In one embodiment, the EGMs 510-1 through 510-N transmit cash-in and cash-out transactions to the kiosk 500 so that the slot management system 575 may undertake accounting services including balancing the transactions taking place at each EGM 510-1 through 510-N. In one embodiment, each kiosk 500 and each of several non-casino locations have internet access such that the data and information from each kiosk 500 at each non-casino location may be transmitted to a remote central server to aggregate and analyze. Ideally, such communications are encrypted. With such an embodiment, gaming tickets may be redeemed at different non-casino locations. Wide area progressive jackpots may also be facilitated by kiosks 500 having internet access and in communication with the remote central server.

The kiosk CPU 570 is a critical component given that the kiosk CPU 570 is integral to the myriad tasks the kiosk 500 needs to perform. If the kiosk CPU 570 fails, the EGMs 510-1 through 510-N can print tickets because the S515-1 through 1515-N have internal storage. In one embodiment, to improve redundancy, as shown in FIG. 6, a second CPU 570 is incorporated into the kiosk 500. In one embodiment, the second CPU 580 is configured to operate the slot management system 575 and the gaming ticket database 535 while the first CPU 570 is configured to operate the kiosk 500. If one of the CPUs 570, 580 fails, the other CPU 570, 580 is configured to perform the tasks of the failed CPU 570, 580. Such redundancy decreases system downtime.

While the above detailed description focuses on non-casino locations with small numbers of EGMs, the kiosk system may also be installed in a small casino location having a limited number of EGMs (e.g., approximately 100 EGMs) and function as detailed above.

The above details operation is described in a gaming ticket environment. Those skilled in the art will recognize that the system described herein will work the same in a card-based environment.

Although the invention has been described in detail with reference to several embodiments, additional variations and modifications exist within the scope and spirit of the invention as described and defined in the following claims.

I claim:

1. A kiosk comprising:
a processor;
a database;
a display;
a gaming ticket validator; and
a slot management system communicatively linked to a plurality of electronic gaming machines.

2. The kiosk of claim 1 further comprising one or more of the following:
a bill dispenser;
a card reader;
a PIN pad;
a camera;
an electronic lock;
a second processor;
a bill validator; and
an uninterruptable power supply.

3. The kiosk of claim 1 further comprising a WiFi access point for providing internet access.

4. The kiosk of claim 1 wherein said slot management system is communicatively linked to a plurality of local electronic gaming machines in a non-casino location with no more than fifteen electronic gaming machines.

5. The kiosk of claim 1 wherein said slot management system is communicatively linked to a plurality of local electronic gaming machines.

6. A gaming system comprising:
a kiosk including a processor, a database, a display and a gaming ticket validator, said processor running a slot management system;
a plurality of local electronic gaming machines; and
wherein said slot management system is communicatively linked to said plurality of electronic gaming machines.

7. The gaming system of claim 6 wherein said kiosk further includes one or more of the following:
a bill dispenser;
a card reader;
a PIN pad;
a camera;
an electronic lock;
a second processor;
a bill validator; and
an uninterruptable power supply.

8. The gaming system of claim 6 wherein said kiosk further includes a WiFi access point for providing internet access.

9. The gaming system of claim 6 wherein said slot management system is communicatively linked to a plurality of local electronic gaming machines in a non-casino location with no more than fifteen electronic gaming machines.

10. The gaming system of claim 9 further comprising a network switch between said local electronic gaming machines and said kiosk.

11. The gaming system of claim 7 wherein said processor manages kiosk operations and said second processor runs said slot management system.

12. The gaming system of claim 11 wherein said processor is configured to run said slot management system and said second processor is configured to manage kiosk operations.

13. The gaming system of claim 6 wherein said slot management system is communicatively linked to a plurality of local electronic gaming machines.

14. A gaming system comprising:
a plurality of kiosks, each kiosk forming said plurality of kiosks including a processor, a database, a display and a gaming ticket validator, said processor running a slot management system, each said kiosk forming said plurality of kiosks installed in a different non-casino location;
each non-casino location including a plurality of local electronic gaming machines;
a central server communicatively linked to each said kiosk forming said plurality of kiosks; and
wherein said slot management system of each said kiosk forming said plurality of kiosks is communicatively linked to one of said plurality of electronic gaming machines in a same non-casino location.

15. The gaming system of claim 14 wherein each kiosk forming said plurality of kiosks further includes one or more of the following:
a bill dispenser;
a card reader;
a PIN pad;
a camera;
an electronic lock;
a second processor;
a bill validator; and
an uninterruptable power supply.

16. The gaming system of claim 14 wherein each kiosk forming said plurality of kiosks further includes a WiFi access point for providing internet access.

17. The gaming system of claim 14 wherein each said slot management system is communicatively linked to a plurality of local electronic gaming machines in a non-casino location with no more than fifteen electronic gaming machines.

18. The gaming system of claim 17 further comprising a network switch between said slot management system of each said kiosk forming said plurality of kiosks is communicatively linked to one of said plurality of local electronic gaming machines in a same non-casino location.

19. The gaming system of claim 15 wherein said processor of each kiosk forming said plurality of kiosks manages kiosk operations and said second processor of each kiosk forming said plurality of kiosks runs said slot management system.

20. The gaming system of claim 19 wherein said processor of each kiosk forming said plurality of kiosks is configured to run said slot management system and said second processor of each kiosk forming said plurality of kiosks is configured to manage kiosk operations.

21. The gaming system of claim 14 wherein said central server is configured to run a wide area progressive jackpot across said different non-casino locations.

22. The gaming system of claim 14 wherein said central server is configured to allow each kiosk forming said plurality of kiosks to redeem a gaming ticket from any one of said different non-casino locations.

23. The kiosk of claim 14 wherein said slot management system is communicatively linked to a plurality of local electronic gaming machines.
